(19) United States
(12) Patent Application Publication
(10) Pub. No.: US 2010/0107231 A1
(43) Pub. Date: Apr. 29, 2010

(54) FAILURE INDICATION

(75) Inventors: Alan Kavanagh, Montreal (CA); Suresh Krishnan, Montreal (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET L M ERICSSON (PUBL), Stockholm (SE)

(21) Appl. No.: 12/582,544

(22) Filed: Oct. 20, 2009

Related U.S. Application Data
(60) Provisional application No. 61/106,661, filed on Oct. 20, 2008.

(51) Int. Cl. H04L 9/32; G06F 21/00; G06F 11/07; G06F 15/16

(52) U.S. Cl. 726/7; 714/48; 726/3; 709/229; 714/E11.025

(57) ABSTRACT

Methods and network node in a network for receiving a network access request related to a subscriber via at least one external network interface and treating the network access request by using at least a first function and second function. A failure indication related to the subscriber is obtained from at least one of the first function or the second function. The network access request is thereafter denied by sending an access result via the external network interface. The access result comprises a cause of failure indicating the at least one of the first function or the second function as a source for the failure. The first and second functions may be, for instance, an AAA function and a DHCP function.

### PRIORITY STATEMENT UNDER 35 U.S.C S.119 (e) & 37 C.F.R. S.1.78

This non-provisional patent application claims priority based upon the prior U.S. provisional patent application entitled “FAILURE INDICATION”, application No. 61/106,661 filed on Oct. 20, 2008, in the names of Alan KAVANAGH and Suresh KRISHNAN.

### TECHNICAL FIELD

The present invention relates to network access control and, more precisely, to network access control when multiple entities can impact the decision to deny network access.

### BACKGROUND

In the context of the present invention, when a subscriber connects to a network via an Access Node, the subscriber needs to receive configuration parameters such as an IP address (e.g., via Dynamic Host Configuration Protocol (DHCP)) and needs to be authenticated to the network before being granted access to any service. The Access Node communicates with an IP Edge node that acts as (or communicates with) a DHCP server to provide the configuration parameters. The IP Edge Node, upon receiving the subscriber's set of credentials, also sends those to the network's Authentication Server (e.g., Authentication, Authorization and Accounting (AAA)) to validate, for instance, that the subscriber is permitted access to the network. The subscriber's set of credentials can be passed to the Authentication Server using various transport methods or protocols such as RADIUS, 802.1x, PANA or DHCP_Authentication (or DHCP_Auth), which is currently being pushed in DSL-Forum and at the IETF. The DHCP_Auth protocol carries the set of credentials supplied by the subscriber in an Extensible Authentication Protocol (EAP) message for the access node to the AAA. For instance, the set of credentials can be carried or encapsulated in a DHCP EAP message sent from the subscriber towards the IP Edge node, which then decapsulates the EAP message and sends the set of credential to the Authentication Server using RADIUS. Upon successful authentication, the Authentication Server returns an Access_Accept message to the IP Edge node. A DHCP_Offer issued from the DHCP Server is then sent to the subscriber to pass the configuration parameters (e.g., an IP Address).

If the Authentication is not successful or if the DHCP server fails to assign proper configuration parameters, the IP Edge node may or may not send a DHCPNAK towards the subscriber.

The present invention addresses the issue of authentication failure and/or DHCP failure.

### SUMMARY

A first aspect of the present invention is directed to a method for reporting a cause of access request denial in a network. The method comprises the step of receiving, at a network node of the network via an external network interface of the network node, a network access request related to a subscriber. The method follows with a step of treating the network access request related to the subscriber at the network node by using a plurality of functions. A result from each of the plurality of functions is needed to decide on the network access request related to the subscriber. In network node, a failure indication related to the subscriber is thereafter obtained as the result from at least one of the plurality of functions. A step follows of denying the network access request by sending an access result to the subscriber via the external network interface. The access result comprises a cause of failure at least indicating the at least one of the plurality of functions as a source for the failure.

Optionally, the step of treating the network access request related to the subscriber may comprise issuing a first request related to the subscriber and issuing a second request related to the subscriber respectively to first and second functions of the plurality of functions. In this exemplary option, the network access request related to the subscriber may comprise credentials of the subscriber. If the second function is an authentication function, then the second request related to the subscriber may further comprise the received credentials of the subscriber.

Optionally, the access result may comprise the failure indication previously received.

Prior to denying, the method could optionally comprise step of obtaining a plurality of failure indications related to the subscriber as the result from at least two of the plurality of functions. The cause of failure would then further indicate the at least two of the plurality of functions as sources for the failure.

An optional exemplary implementation of the present invention specifies that the first function is a Dynamic Host Configuration Protocol server (DHCP) function and the second function is an Authentication, Authorization and Accounting (AAA) function.

Under this optional exemplary implementation, the cause of failure could indicate at least one of the AAA function and DHCP function as the source for the failure by indicating that:
the AAA function returned an “invalid credentials” failure indication;
the DHCP function returned a “no IP address available” failure indication;
the AAA function returned a “request timeout” failure indication; and/or
the DHCP function returned a “request timeout” failure indication.

As a further optional exemplary implementation a first function of the plurality of functions may be used to obtain subscriber's access parameters and be collocated with the network node and a second function of the plurality of functions may be used for subscriber's authentication and be located in a further network node in the network. In such an example, the network access request may be a discovery message. The step of treating the network access request would then comprise redirecting the discovery message to the first function via at least one internal interface of the network node and generating a second request related to the subscriber in the network node using a processor thereof before sending the generated second request related to the subscriber to the second function via the external network interface of the network node.

In this further optional exemplary implementation, the first function could be a DHCP server function, the second function could be an AAA function and discovery message could be a DHCP_DISCOVER message. The access result may be a DHCPEAP_FAIL sent to a requestor node from which the network access request related to the subscriber is received.

A second aspect of the present invention is directed to a network node in a network comprising at least one external network interface and a processor that executes instructions for receiving a network access request related to a subscriber via the at least one external network interface. The processor thereafter also executes instructions for treating the network access request related to the subscriber by using at least a first function and second function. The network node thereafter obtains a failure indication related to the subscriber from at least one of the first function or the second function and denies the network access request by sending via the at least one external network interface an access result to the subscriber the access result comprising a cause of failure indicating the at least one of the first function or the second function as a source for the failure.

Optionally, treating the network access request related to the subscriber may comprise issuing a first request related to the subscriber and issuing a second request related to the subscriber respectively to the first and second functions. In this exemplary option, the network access request related to the subscriber may comprise credentials of the subscriber. If the second function is an authentication function, then the second request related to the subscriber may further comprise the received credentials of the subscriber.

The access result could optionally comprise the failure indication previously received.

Prior to denying, the network node could optionally receive a second failure indication related to the subscriber from the other one of the first function or the second function. The cause of failure would then further indicate the first function and the second function as sources for the failure.

An optional exemplary implementation of the present invention suggests that the first function is a Dynamic Host Configuration Protocol server (DHCP) function and that the second function is an Authentication, Authorization and Accounting (AAA) function.

In this optional exemplary implementation, the cause of failure could indicate at least one of the AAA function and DHCP function as the source for the failure by indicating that:
the AAA function returned an “invalid credentials” failure indication;
the DHCP function returned a “no IP address available” failure indication;
the AAA function returned a “request timeout” failure indication; and/or
the DHCP function returned a “request timeout” failure indication.

A further optional exemplary implementation of the present invention, the network node could further comprise the first function and at least one internal interface. The first function can be used to obtain subscriber's access parameters and the second function used for subscriber's authentication and be located in a further network node in the network. The network access request could be a discovery message. In these optional circumstances, treating the network access request could involve redirecting the discovery message to the first function via the at least one internal interface and generating a second request related to the subscriber in the network node using a processor thereof before sending the generated second request related to the subscriber to the second function via the external network interface of the network node.

In this further optional exemplary implementation, the first function could be a DHCP server function, the second function could be an AAA function and discovery message could be a DHCP_DISCOVER message. The access result may be a DHCPEAP_FAIL sent to a requestor node from which the network access request related to the subscriber is received.

A third aspect of the present invention is directed to a method for receiving a request comprising credentials for network access from a subscriber, engaging in DHCP request with a DHCP server function, engaging in Authentication request with AAA function, replying with an access result to the subscriber, the access result comprising a cause of failure indicating at least one of the AAA and DHCP function as a source for the failure.

### BRIEF DESCRIPTION OF THE DRAWINGS

The accompanying drawings, which are incorporated in and constitute a part of the specification, illustrate one or more implementations and, together with the description, explain these exemplary implementations. In the drawings:

FIG. 1 is an exemplary flow chart of network access denial in accordance with the teachings of the present invention;

FIG. 2 is an exemplary modular representation of a network node in accordance with the teachings of the present invention; and

FIGS. 3 and 4 are an exemplary nodal operation and flow charts in accordance with the teachings of the present invention.

### DESCRIPTION OF THE INVENTION AAA Authentication Authorization Accounting

DHCP Dynamic Host Control Protocol

EAP Extensible Authentication Protocol

HGW Home GateWay

RADIUS Remote Authentication Dial-In User Server

RG Residential Gateway

PANA Protocol for carrying Authentication for Network Access

The present invention provides solution by which, in case a network access request is denied, a cause of denial is provided to the requestor. The cause of failure at least indicates which of the plurality of functions involved in granting network access has actually refused access. The cause of failure may be more specific and contain the actual reason of denial as provided by the related function. In one implementation of the present invention, an AAA function and a DHCP function are involved in granting network access. In this exemplary context, a new message type called DHCPEAP_FAIL could be introduced. The DHCPEAP_FAIL message could be sent from the IP edge node towards the requestor. The DHCPEAP_FAIL message would include an Error Indicator that can be used to inform the client why a network access request initiated using a DHCP_DISCOVER message has failed.

The existing solution does not address how a failure is indicated to the client initiating the network access request (e.g., initiated by sending DHCP_Discover message as specified by the DHCP_Auth protocol). If authentication fails for failure to provide sufficient credentials, then the existing solution waits for an EAP fail to be initiated or for a timeout to occur. As the cause of failure is not indicated to the client, the client remains unaware as to why the DHCP_Auth has failed. As a result, the client will either retry with the same credentials or stop the DHCP_Auth leading to the client being unable to access the network.

Similarly the existing solution does not address how a DHCP failure would be indicated to the client in the event, for instance, that the DHCP Server no longer has any IP addresses available to assign to the client initiating the network access request.

The existing solution simply specifies to send a DHCPNAK message back to the requesting client in all failure circumstances. Yet, the DHCPNAK message does not provide a suitable answer back to the client as to why the DHCP_Discover has failed.

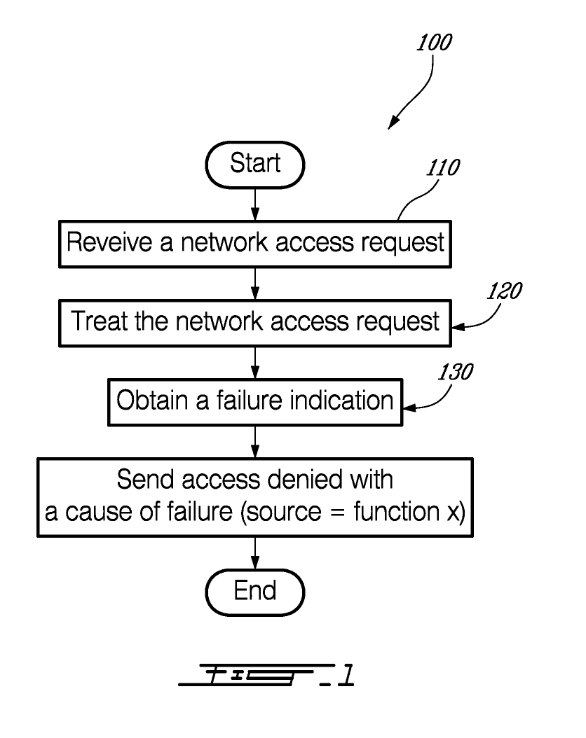

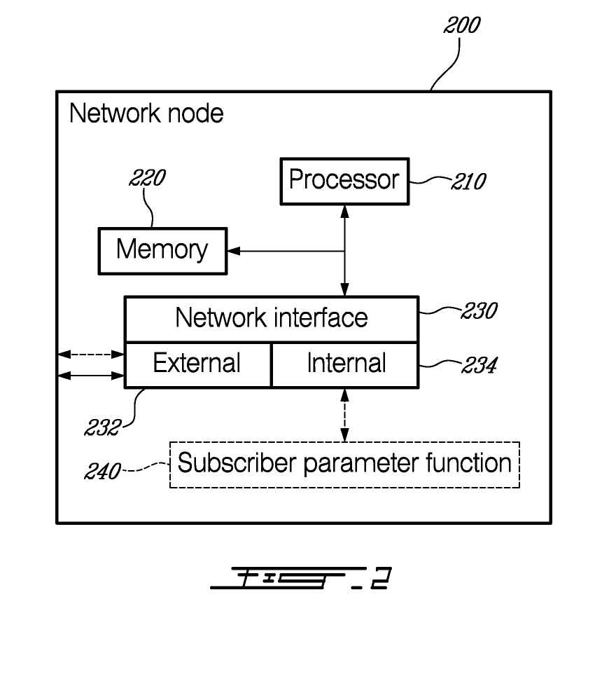

Reference is now made FIG. 1 and FIG. 2 of the drawings. FIG. 1 shows an exemplary flow chart of reporting a cause of access request denial in a network 100 in accordance with the teachings of present invention. FIG. 2 shows an exemplary modular representation of a network node 200 in accordance with the teachings of the present invention. The exemplary flow chart shows step executed in the network node 200 of the network 100. The network node 200 comprises a processor 210 and a memory 220. Persons skilled in the art will readily recognize the various specific requirements on the processor 210 and the memory 220. It should be more specifically noted that multi processor architectures or single purpose processors and multiple types of memory (various RAM, various ROM, disk, flash memory, etc.) can be represented under the simple logical views 210 and 220 of FIG. 2. Likewise, the capacity of the processor 210 and memory 220 is not specified by the present invention, but persons skilled in the art will easily be able to scale such components.

The processor 210 executes instructions for performing steps such as, for instance, the steps shown on FIG. 1. The network node 200 further comprises a network interface module (230). The network interface module 230 comprises at least one external interface 232 (e.g., used to communicate on the network with further nodes (not shown)). The network interface module 230 may also comprise at least one internal interface 234 (e.g., loopback interface or other means used to communicate with other modules of the network node 200, for instance, using messages that could otherwise be sent to further nodes).

The flow chart first shows a step of receiving a network access request 110 related to a subscriber. The network access request is received from a requestor node, the requestor node can be a client device of the subscriber (not shown) or an intermediate node (not shown, e.g., that sent the network access request on behalf of the subscriber). The network access request is received at the network node 200 via the external network interface 232. Upon reception of the network access request, the network node 200 treats the network access request 120 using multiple functions from which a result is needed to decide on the network access request related to the subscriber. Treating the network access request may be done by issuing a first request related to the subscriber to a first function and issuing a second request related to the subscriber to a second function (not shown). The first and second request could be issued or sent simultaneously or sequentially, in any order.

As mentioned earlier, one of the known and exemplary context in which the present invention can be useful is when the first function is a Dynamic Host Configuration Protocol server (DHCP) function and the second function is an Authentication, Authorization and Accounting (AAA) function. Of course, person skilled in the art will readily recognize other functions involved in granting or denying network access that could be used in the context of the present invention (e.g., various authentication protocols or services, admission control services (based on Quality-of-Service (QoS) requirements or Service Level Agreement (SLA) parameters), automatic subscriber's parameters protocols, etc.).

Following the step 120, the network node 200 obtains a failure indication related to the subscriber from one of the multiple functions 130. Of course, it is also possible to receive a second failure indication related to the subscriber from another one of the functions (not shown). It is readily apparent, however, that only one failure is necessary to refuse the network access request. The skilled reader will also appreciate that some failure indications may not lead to denial of the network access request. For instance, some failures may be linked to the relation between the function and the network node 200 itself. Such none-critical or not subscriber-related failures may or not require communication to the subscriber and, as such, the teachings of the present invention may or not apply. The skilled will readily recognize the contexts in which the teachings of the present invention can be used.

The network node 200 thus denies network access request by sending via the external network interface 232 an access result to the subscriber 140. The access result comprises a cause of failure at least indicating the relevant function as the source for the failure. Optionally, the access result may comprise the failure indication previously received. The access result may be more specific and include further details such as: the AAA function returned an “invalid credentials” failure indication, the DHCP function returned a “no IP address available” failure indication, the AAA function returned a “request timeout” failure indication; and/or the DHCP function returned a “request timeout” failure indication.

The first function may be collocated with the network node 200 and be used to obtain subscriber's access parameters (240) (such as a DHCP function). The second function may be used for subscriber's authentication (such as an AAA function) and be located in a further network node in the network 100. The network access request 110 may also be a discovery message (e.g., parameter discovery message such as a DHCP_DISCOVER or a network discovery such as a router solicitation (RTSOL)) and may contain subscriber's credentials (e.g., in the discovery message or in a further message part of the network access request). Treating the network access request 120 may thus involve multiple sub aspects. For instance, treating the network access request could involve redirecting the discovery message to the subscriber's access parameters 240 via the internal interface 234 of the network node 200. It could also comprise generating the second request related to the subscriber in the network node using the processor 210 (including the subscriber's credentials if received and). The generated second request related to the subscriber to the second function may thereafter be sent via the external network interface 232 of the network node 200. Generating the second request may further comprise generating a credential request message (e.g., DHCPEAP_RES message) to be sent to the requestor node to acquire, for instance, the subscriber's credentials. The access result may be a DHCPEAP_FAIL sent to the requestor node from which the network access request related to the subscriber is received.

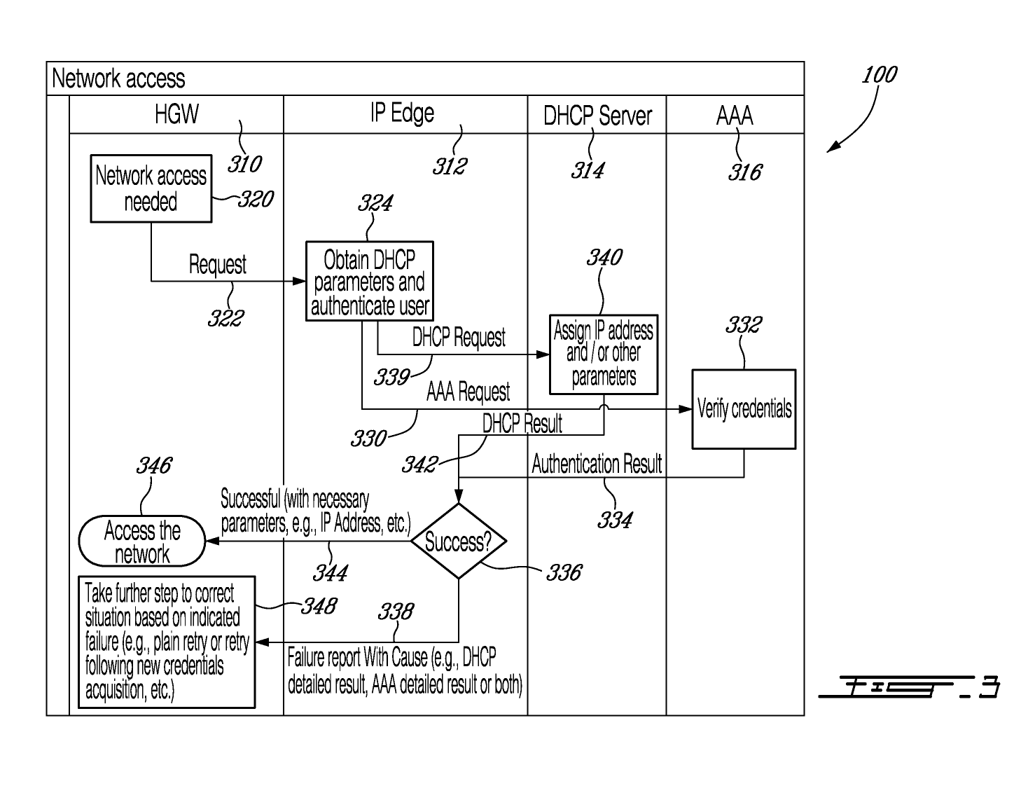

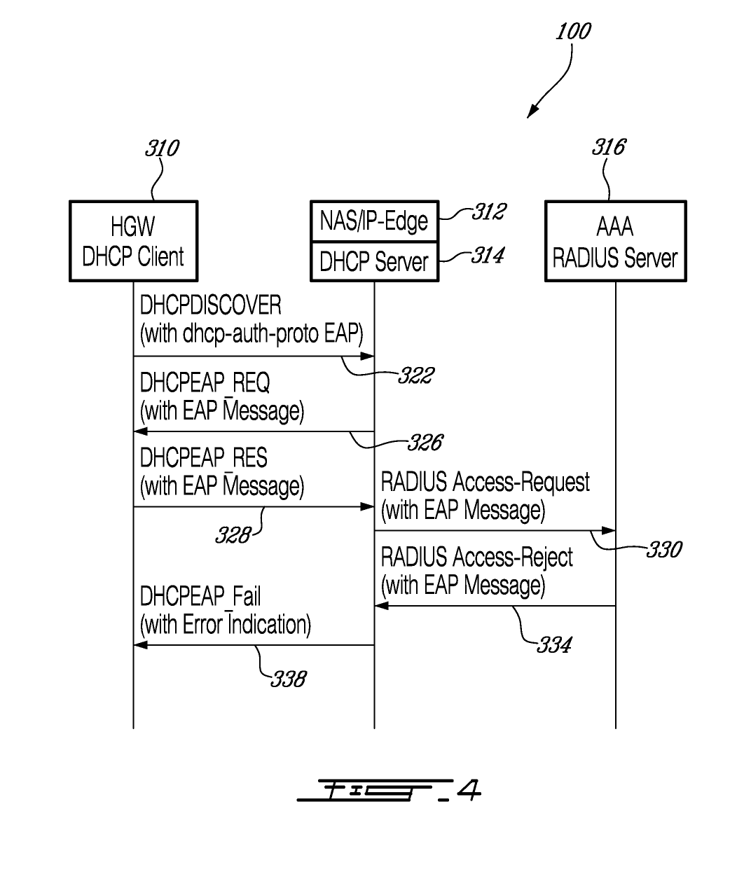

A more specific example is presented on FIGS. 3 and 4, which show exemplary nodal operation and flow charts of network access taking place within the network 100, in accordance with the teachings of the present invention. FIG. 3 shows a Home Gateway (HGW) 310, an IP Edge Node 312, a DHCP Sever 314 and an AAA Server 316. The IP Edge node 312 may be acting as the access node for the network 100. When a client (not shown) attaches to a network (e.g., LAN) of the HGW 310, or HGW 310 is powered-on and is attaching to the network 100, the HGW detects a need for a network access (320). A DHCPEAP Client of the HGW 310 sends a network access request 322 such as a DHCP_DISCOVER Message type which is broadcast upstream towards the IP Edge Node 312. In this message 322, the client indicates the type of authentication protocol method which it intends to use to authenticate for network access. In the example shown on FIG. 4, it is EAP. Other authentication options include PAP and CHAP. Persons skilled in the art will readily recognize other applicable authentication protocols. The IP Edge Node 312 thus need to obtain DHCP parameters and perform authentication (324). In the example of FIG. 4, the IP Edge node 312 is collocated with the DHCP Server 314, supports the EAP method and sends a DHCPEAP_REQ 326 to the client initiating the EAP challenge and the client responds by sending a DHCPEAP_RES 328 to the DHCP Server 314.

The IP Edge Node 312 collocated with or acting as the DHCP Server 314 extracts the EAP message from the DHCPEAP_RES message 328 and sends this in a RADIUS Access_Request 330 message to the AAA Server 316. The AAA Server 316 in the example of FIGS. 3 and 4 verify the credentials (332) and determines that it is unable to authenticate the client due to, e.g., incorrect authentication credentials provided by the client and returns a RADIUS Access-Reject message 334 to the IP Edge Node 312. The IP Edge Node 312/DHCP Server 314 then determine if the authentication was successful (336) and, since the AAA server 316 rejected the request 330, it sends a DHCPEAP_FAIL message 338 to the client with and Error Indication noting the cause of failure is due to the client supplying an incorrect authentication credential in the DHCPEAP_RES message 328. Optionally, before or following a positive verification 336 related to the AAA Server 316, the IP Edge Node 312 and the DHCP Server 314 may exchange a DHCP request 338 for the DHCP Sever 314 to assign parameters 340 to the related subscriber. The DHCP Server 314 sends the result of the assignment 340 to the IP Edge Node 312 (342). In case of success in 336, the necessary parameters are sent 344 (e.g., DHCPOFFER with EAP success message), which enable the client to access the network 346.

In case of failure, the client may note the received error from 338 and attempts to either resend a new authentication credential or informs the user to fix the problem manually.

The DHCP_AUTH is typically between a Home or Residential Gateway (HGW or RG) and an IP Edge Node. The IP_Edge node can use the DHCP_Auth to do two things: 1) send a DHCP_Offer to the RG which would forward/relay this to the PC behind the RG and 2) authenticate the user by sending a RADIUS_ACCESS_REQUEST to the AAA Server behind the IP_Edge node.

The IP_Edge node should first form a RADIUS_Request message that is sent to the AAA Server. The AAA Server returns a RADIUS_Accept upon successfully authenticating the subscriber. The IP Edge node then sends a DHCP_Discover message, which the DHCP Server returns a DHCP_Offer to the RG with an IP_Address for the subscriber. This example implies everything has been successful.

In case of failure, the IP Edge node sends a RADIUS_Request message to the AAA Server, the AAA does not successfully authenticate the subscriber and returns a “RADIUS Reject” message to the IP Edge node. The IP Edge node sends a DHCP_Auth_Fail message indicating that authentication failed.

As another example, the IP Edge node sends a RADIUS_Request to the AAA Server. The AAA Server successfully authenticates the subscriber and returns a RADIUS_Accept to the IP Edge node. The IP Edge node now sends a DHCP_Discover message to the DHCP Server. Unfortunately no response is received and no IP_Address is obtained by the IP Edge node for the subscriber. The IP Edge node sends a DHCP_Auth_Fail message to the subscriber indicating that a DHCP Failure has occurred.

The order in which the DHCP and AAA interactions with the IP Edge node occur do not affect the present invention. Likewise, there could be many different types and level of information provided in the failure indication sent to the subscriber, as long as the subscriber is made aware of at least one function (e.g., AAA and/or DHCP) responsible for the rejection. Furthermore, the present invention is herein described by way of examples that should be construed as an exhaustive list of examples in which the present invention applies. A subscriber, in the present description, should be construed generally as representing the client side that requires connection to the network (could represent the actual user, a device on the client side, a gateway on the client side, etc.). The DHCP server is likely collocated with the IP edge node and could therefore be seen as a function therefore or as an independent node providing the function. More generally, the DHCP and AAA servers could be seen as function located in any relevant node of the network, which does not affect the present invention.

The proposed invention provides a mechanism for the DHCPEAP Server to indicate when and why DHCPEAP Authentication has failed. This makes it possible for the DHCPEAP client to know the reason of failure, and when applicable retry with the error fixed. For example, it may have been that authentication timed-out, and all that is required is for the DHCPEAP client to initiate a new DHCPEAP Authentication procedure. Another example is where the authentication credential supplied by the client in the DHCPEAP_RES is not valid. The DHCPEAP_FAIL indicates that authentication has failed due to invalid authentication token. The client is notified of the authentication failure due to invalid authentication token in the DHCPEAP_FAIL message, and the client will then retry with an updated authentication token.

The preceding description of exemplary implementations of the present invention refers to the accompanying drawings in which the same reference numbers in different drawings identify the same or similar elements. The detailed description does not limit the invention. Instead, the scope of the invention is defined by the appended claims.

What is claimed is:

1. A method for reporting a cause of access request denial in a network, the method comprising the steps of:
receiving, at a network node of the network via an external network interface of the network node, a network access request related to a subscriber;
treating, at the network node, the network access request related to the subscriber by using a plurality of functions, wherein a result from each of the plurality of functions is needed to decide on the network access request related to the subscriber;
obtaining in the network node, a failure indication related to the subscriber as the result from at least one of the plurality of functions; and
denying the network access request by sending via the external network interface an access result, the access result comprising a cause of failure at least indicating the at least one of the plurality of functions as a source for the failure.

2. The method of claim 1 wherein the step of treating the network access request related to the subscriber comprises:
issuing, from the network node to a first function of the plurality of functions, a first request related to the subscriber; and
issuing, from the network node to a second function of the plurality of functions, a second request related to the subscriber.

3. The method of claim 2 wherein:
the network access request related to the subscriber comprises credentials of the subscriber;
the second function is an authentication function; and
the second request related to the subscriber comprises the received credentials of the subscriber.

4. The method of claim 1 wherein the access result comprises the failure indication previously received.

5. The method of claim 1 further comprising steps of, prior to the step of denying, obtaining, in the network node a plurality of failure indications related to the subscriber as the result from at least two of the plurality of functions, wherein the cause of failure further indicates the at least two of the plurality of functions as sources for the failure.

6. The method of claim 1 wherein a first function of the plurality of functions is a Dynamic Host Configuration Protocol server (DHCP) function and a second function of the plurality of functions is an Authentication, Authorization and Accounting (AAA) function.

7. The method of claim 6 wherein the cause of failure indicates at least one of the AAA function and the DHCP function as the source for the failure by indicating that:
the AAA function returned an “invalid credentials” failure indication;
the DHCP function returned a “no IP address available” failure indication;
the AAA function returned a “request timeout” failure indication; and/or
the DHCP function returned a “request timeout” failure indication.

8. The method of claim 2 wherein the second function is an authentication function located in a further network node in the network and wherein the step of issuing the second request to the authentication function involves the external network interface of the network node.

9. The method of claim 2 wherein the first function is a DHCP function collocated with the network node and wherein the step of issuing the first request to the DHCP function involves at least one internal interface of the network node.

10. The method of claim 9 wherein:
the network access request is a DHCP_DISCOVER message;
the step of issuing the first request to the DHCP function involves redirecting the DHCP_DISCOVER message to the DHCP function;
the second function is an authentication function located in a further network node in the network; and
the step of issuing the second request to the authentication function further comprises:
generating the second request related to the subscriber in the network node using a processor thereof; and
sending the generated second request related to the subscriber to the authentication function via the external network interface of the network node.

11. The method of claim 10 wherein the access result is a DHCPEAP_FAIL sent to a requestor node from which the network access request related to the subscriber is received.

12. The method of claim 1 wherein:
a first function of the plurality of functions is used to obtain subscriber's access parameters and is collocated with the network node;
a second function of the plurality of functions is used for subscriber's authentication and is located in a further network node in the network;
the network access request is a discovery message; and
the step of treating the network access request comprises:
redirecting the discovery message to the first function via at least one internal interface of the network node;
generating a second request related to the subscriber in the network node using a processor thereof; and
sending the generated second request related to the subscriber to the second function via the external network interface of the network node.

13. A network node in a network comprising:
at least one external network interface; and
a processor that executes instructions for:
receiving a network access request related to a subscriber via the at least one external network interface;
treating the network access request related to the subscriber by using at least a first function and second function;
obtaining a failure indication related to the subscriber, from at least one of the first function or the second function; and
denying the network access request by sending via the at least one external network interface an access result, the access result comprising a cause of failure indicating the at least one of the first function or the second function as a source for the failure.

14. The network node of claim 13 wherein treating the network access request related to the subscriber comprises:
issuing, from the network node to the first function, a first request related to the subscriber; and
issuing, from the network node to the second function, a second request related to the subscriber.

15. The network node of claim 14 wherein:
the network access request related to the subscriber comprises credentials of the subscriber;
the second function is an authentication function; and
the second request related to the subscriber comprises the received credentials of the subscriber.

16. The network node of claim 13 wherein the access result comprises the failure indication previously received.

17. The network node of claim 13 wherein the processor executes further instructions for, prior to denying, obtaining a second failure indication related to the subscriber from the other one of the first function or the second function, wherein the cause of failure further indicates the first function and the second function as sources for the failure.

18. The network node of claim 13 wherein the first function is a Dynamic Host Configuration Protocol server (DHCP) function and the second function is an Authentication, Authorization and Accounting (AAA) function.

19. The network node of claim 18 wherein the cause of failure indicates at least one of the AAA function and DHCP function as the source for the failure by indicating that:
the AAA function returned an “invalid credentials” failure indication;
the DHCP function returned a “no IP address available” failure indication;
the AAA function returned a “request timeout” failure indication; and/or
the DHCP function returned a “request timeout” failure indication.

20. The network node of claim 14 wherein the second function is an authentication function located in a further network node in the network and wherein the step of issuing the second request to the authentication function involves the at least one external network interface.

21. The network node of claim 14 further comprising at least one internal interface, wherein:
the first function being a DHCP function in the network node; and
issuing the first request is performed by sending the first request to the DHCP function via the at least one internal interface.

22. The network node of claim 21 wherein:
the network access request is a DHCP_DISCOVER message;
issuing the first request to the DHCP function involves redirecting the DHCP_DISCOVER message to the DHCP function;
the second function is an authentication function located in a further network node in the network; and
issuing the second request to the authentication function further comprises:
generating the second request related to the subscriber in the network node using the processor; and
sending the generated second request related to the subscriber to the authentication function via the at least one external network interface.

23. The network node of claim 22 wherein the access result is a DHCPEAP_FAIL sent to a requestor node from which the network access request related to the subscriber is received.

24. The network node of claim 12 further comprises the first function and at least one internal interface wherein:
the first function is used to obtain subscriber's access parameters;
the second function is used for subscriber's authentication and is located in a further network node in the network;
the network access request is a discovery message; and
treating the network access request comprises:
redirecting the discovery message to the first function via the at least one internal interface;
generating a second request related to the subscriber in the network node using the processor; and
sending the generated second request related to the subscriber to the second function via the at least one external network interface of the network node.

25. A method for treating network access request in a network node comprising the steps of:
receiving a request comprising credentials for network access from a subscriber;
engaging in DHCP request with a DHCP server function;
engaging in Authentication request with AAA function;
replying, via an external network interface reo the network node, with an access result to the subscriber, the access result comprising a cause of failure indicating at least one of the AAA and DHCP function as a source for the failure.
